(19) United States
(12) Patent Application Publication
(10) Pub. No.: US 2026/0081846 A1
(43) Pub. Date: Mar. 19, 2026

(54) Security for AI/ML Model Storage and Sharing

(71) Applicant: Telefonaktiebolaget LM Ericsson (publ), Stockholm (SE)

(72) Inventors: Pinar Çomak De Cnudde, Berlare (BE); Christine Jost, Dalby (SE); Cheng Wang, Shanghai (CN); Ferhat Karakoc, Istanbul (TR); Songmao Li, Shanghai (CN); Dan Xu, Gothenburg (SE); Ulf Mattsson, Kungsbacka (SE); Zhang Fu, Stockholm (SE)

(21) Appl. No.: 19/109,408

(22) PCT Filed: Sep. 26, 2023
(86) PCT No.: PCT/EP2023/076517

§ 371 Date: Mar. 6, 2025

(30) Foreign Application Priority Data
Sep. 30, 2022 (WO) PCT/CN2022/123452

(51) Int. Cl. H04L 41/16; H04L 41/14

(52) U.S. Cl. CPC H04L 41/16; H04L 41/145

(57) ABSTRACT

Embodiments include methods for a consumer network function (NFc) of a communication network. Such methods include sending, to a first NF of the communication network, a first request for a first access token associated with a machine learning (ML) model. The first request includes at least one of the following associated with the ML model: an analytics identifier (ID), and an interoperability ID. Such methods include receiving from the first NF a first response that includes the first access token and sending, to a producer NF (NFp) of the communication network, a second request for the ML model. The second request includes the first access token and at least one of the analytics ID and the interoperability ID. Such methods include receiving from the NFp a second response that includes one or more of the following: the ML model; an identifier of the ML model; and an address of a storage resource associated with a second NF of the communication network, from which the ML model can be obtained.

### TECHNICAL FIELD

The present application relates generally to the field of communication networks, and more specifically to techniques for security of artificial intelligence/machine learning (AI/ML) models used to generate analytics in a communication network (e.g., a 5G core network).

### INTRODUCTION

Currently the fifth generation (5G) of cellular systems is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

NG RAN logical nodes (e.g., gNB 100) include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. In general, the various services are self-contained functionalities that can be changed and modified in an isolated manner without affecting other services. Also, the services are composed of various “service operations”, which are more granular divisions of the overall service functionality. The interactions between service consumers and producers can be of the type “request/response”or “subscribe/notify”.

A 5GC NF that is of particular interest in the present disclosure is the Network Data Analytics Function (NWDAF). This NF provides network analytics information (e.g., statistical information of past events and/or predictive information) to other NFs on a network slice instance level. The NWDAF can collect data from any 5GC NF. Note that a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice.

Machine learning (ML) is a type of artificial intelligence (AI) that focuses on the use of data and algorithms to imitate the way that humans learn, gradually improving accuracy as more data becomes available. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks. A subset of ML is closely related to computational statistics.

The 5G system architecture allows any NF to obtain analytics from an NWDAF using a Data Collection Coordination Function (DCCF) and associated Ndccf services. The NWDAF can also store and retrieve analytics information from an Analytics Data Repository Function (ADRF). 3GPP TS 23.288 (v17.2.0) specifies that NWDAF is the main NF for computing analytics reports, and classifies NWDAF into two sub-functions (or logical functions): Analytics Logical Function (AnLF), which performs analytics procedures; and Model Training Logical Function (MTLF), which performs training and retraining of ML models used by the AnLF.

### SUMMARY

AI/ML models (or more simply, ML models) are generally considered important intellectual property of their owners (e.g., 5GC vendors) and, as such, need to have their confidentiality and integrity protected at all times. 3GPP is studying the feasibility of sharing or storing ML models in network equipment that may be provided by different vendors. In this arrangement, an ML model should be protected from access and use by consumer NFs that are provided by different vendors than the ML model. Currently, however, there are no specified solutions to this requirement.

An object of embodiments of the present disclosure is to address these and related problems, issues, and/or difficulties, thereby facilitating the otherwise-advantageous deployment of ML models for network analytics.

Some embodiments of the present disclosure include methods (e.g., procedures) for a consumer NF (NFc) of a communication network (e.g., 5GC).

These exemplary methods include sending, to a first NF of the communication network, a first request for a first access token associated with an ML model. The first request includes one or more of the following associated with the ML model: an analytics ID, and an interoperability ID. These exemplary methods also include receiving from the first NF a first response that includes the first access token. The exemplary method can also include sending to a producer NF (NFp) of the communication network a second request for the ML model. The second request includes the first access token and at least one of the analytics ID and the interoperability ID. These exemplary methods also include receiving from the NFp a second response that includes one or more of the following: the ML model, an identifier of the ML model, and an address of a storage resource associated with a second NF of the communication network, from which the ML model can be obtained.

In some embodiments, first NF is a network repository function (NRF). In other embodiments, the first NF is an analytics data repository function (ADRF). In some embodiments, the second NF is the NFp. In other embodiments, the second NF is an ADRF. In some embodiments, one or more of the following applies: the NFc is an NWDAF (AnLF), and the NFp is an NWDAF (MTLF).

Other embodiments include exemplary methods (e.g., procedures) for an NFp of a communication network (e.g., 5GC).

These exemplary methods include registering information associated with an ML model in an NRF of the communication network. The ML model is produced, owned, and/or maintained by the NFp. The registered information associated with the ML model includes an analytics ID and an interoperability ID. These exemplary methods also include encrypting the ML model and sending to an ADRF of the communication network a first request to store the encrypted ML model. The first request includes the encrypted ML model or a first address of a storage resource associated with the NFp, from which the ML model can be obtained.

In some embodiments, these exemplary methods can also include receiving, from an NFc of the communication network, a second request for the ML model. The second request includes a first access token and at least one of the analytics ID and the interoperability ID. These exemplary methods can also include, based on verifying the first access token, sending to the NFc a second response that includes one or more of the following: the ML model; an identifier of the ML model; the first address of the storage resource associated with the NFp; and a second address of a storage resource associated with the ADRF, from which the ML model can be obtained.

In some embodiments, one or more of the following applies: the NFc is an NWDAF (AnLF), and the NFp is an NWDAF (MTLF).

Other embodiments include methods (e.g., procedures) for an NRF of a communication network (e.g., 5GC).

These exemplary methods can include registering information associated with an ML model that is produced, owned, and/or maintained by an NFp of the communication network. The registered information associated with the ML model includes an analytics ID and an interoperability ID. These exemplary methods can also include receiving, from an NFc of the communication network, a first request for a first access token associated with the ML model. The first request includes at least one of the analytics ID and the interoperability ID. These exemplary methods can also include sending to the NFc a first response that includes the first access token.

In some embodiments, these exemplary methods can also include receiving, from a first NF of the communication network, a second request for a second access token. The second request includes at least one of the analytics ID and the interoperability ID, and one of the following:
a first address of a storage resource associated with the NFp, from which the ML model can be obtained; or
a second address of a storage resource associated with an ADRF of the communication network, from which the ML model can be obtained.
   These exemplary methods can also include sending to the first NF a second response that includes the second access token.

In some of these embodiments, the first address of the storage resource associated with the NFp is a first universal resource locator (URL). and the second address of a storage resource associated with the ADRF is a second URL or a fully qualified domain name (FQDN). In some of these embodiments, the first NF is the NFc. In other of these embodiments, the first NF is the NFp.

Other embodiments include methods (e.g., procedures) for an ADRF of a communication network (e.g., 5GC).

These exemplary methods can include receiving, from an NFp of the communication network, a first request to store an encrypted ML model. The first request includes the encrypted ML model or a first address of a storage resource associated with the NFp, from which the encrypted ML model can be obtained. These exemplary methods can also include storing the encrypted ML model in a storage resource associated with the ADRF. These exemplary methods can also include sending to the NFp a first response that includes a second address of the storage resource associated with the ADRF.

In some embodiments, the first NF is the NFp. In other embodiments, the first NF is an NFc of the communication network. In some embodiments, the NFc is an NWDAF (AnLF) and/or the NFp is an NWDAF (MTLF). In some embodiments, the first address of the storage resource associated with the NFp is a first URL and the second address of a storage resource associated with the ADRF is a second URL or an FQDN.

Other embodiments include NFc's, NFp's, NRFs, and ADRFs (or network nodes hosting such NFs) that are configured to perform the operations corresponding to any of the exemplary methods described herein. Other embodiments also include non-transitory, computer-readable media storing computer-executable instructions that, when executed by processing circuitry, configure such network nodes or NFs to perform operations corresponding to any of the exemplary methods described herein.

These and other disclosed embodiments can provide various benefits and/or advantages. By providing the ML model owner/producer with the ability to protect the ML model during various transfer, storage, and retrieval scenarios, embodiments improve the security of confidential and/or sensitive ML models and thereby facilitate deployment of such models in a multi-vendor communication network, such as 5GC.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows a signaling diagram of a network procedure for authorization and authentication of AI/ML model transfer.

FIG. 4 shows a signaling diagram of a procedure involving an NWDAF(AnLF), an NRF, an NWDAF(MTLF), and an ADRF, according to some embodiments of the present disclosure.

FIG. 5 (which includes FIGS. 5A-B) shows a signaling diagram of another procedure involving an NWDAF(AnLF), an NRF, an NWDAF(MTLF), and an ADRF, according to other embodiments of the present disclosure.

FIG. 6 shows an exemplary method (e.g., procedure) for a consumer NF of a communication network, according to various embodiments of the present disclosure.

FIG. 7 shows an exemplary method (e.g., procedure) for a producer NF of a communication network, according to various embodiments of the present disclosure.

FIG. 8 shows an exemplary method (e.g., procedure) for an NRF of a communication network, according to various embodiments of the present disclosure.

FIG. 9 shows an exemplary method (e.g., procedure) for an ADRF of a communication network, according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, according to various embodiments of the present disclosure.

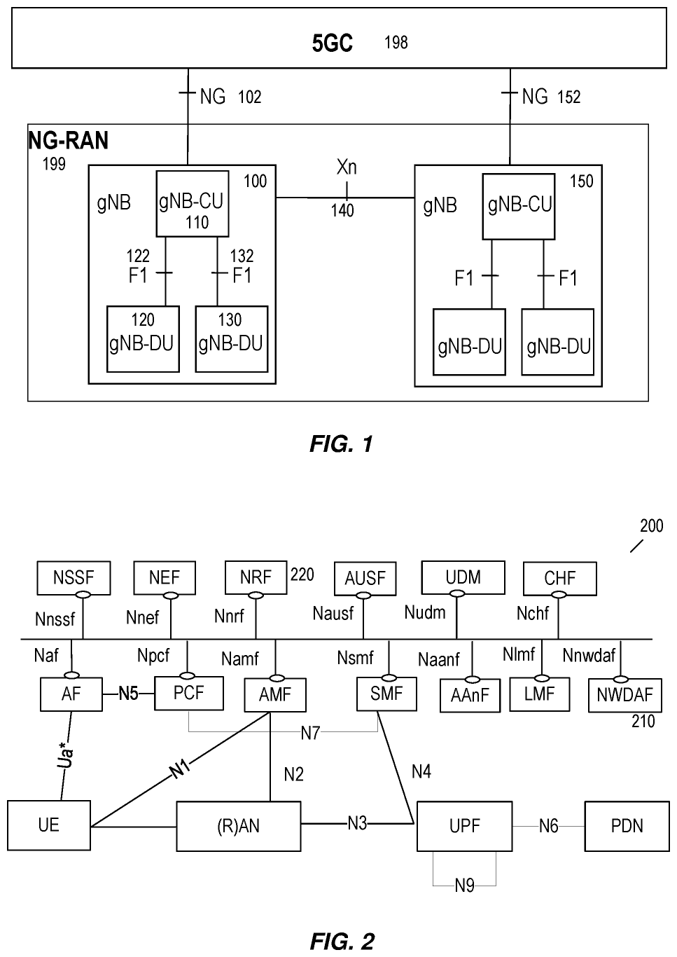

### DETAILED DESCRIPTION

Embodiments briefly summarized above will now be described more fully with reference the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein not have to be performed in the exact order disclosed, unless an operation is explicitly described following or preceding another operation and/or where it is implicit that an operation must follow or precede another operation. Any feature of any embodiment disclosed herein can apply any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same similar terminology. Nevertheless, to the extent that such other explanations and/or descriptions conflict with the above definitions, the above definitions should control.

Note that the description given herein focuses on a 3GPP cellular communications system as such, 3GPP terminology or terminology similar to 3GPP terminology is oftentimes used. However, the concepts disclosed herein are not limited to a 3GPP system and can be applied to communication system that may benefit from them. Furthermore, although the term “cell” is herein, it should be understood that (particularly with respect to 5G NR) beams may be used instead of cells and, as such, concepts described herein apply equally to both cells and beams.

FIG. 2 shows an exemplary architecture for a 5GC (200), with service-based interfaces various 3GPP-defined NFs within the Control Plane (CP). These include the following:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)-supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing capabilities and events of the 5GC NFs to AFs within and outside of the 5GC, and by providing ways for AFs to securely provide information to 3GPP network. For example, NEF provides a service that allows an AF to provision specific subscription data (e.g., expected UE behavior) for various UEs.
Network Repository Function (NRF, 220) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF, 210) with Nnwdaf interface, described in more detail above and below.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to interacting with UDM, the UDR supports storage and retrieval of policy data by the PCF, as well as storage and retrieval of application data by NEF. The Data Storage Function (DSF) allow every NF to store its own context.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-17 enhances the SBA by adding a Data Management Framework that includes a Data Collection Coordination Function (DCCF) and a Messaging Framework Adaptor Function (MFAF), which are defined in detail in 3GPP TR 23.700-91 (v17.0.0). The Data Management Framework is backward compatible with a Rel-16 NWDAF function, described above. For Rel-17, the baseline for services offered by the DCCF (e.g., to an NWDAF) are the Rel-16 NF Services used to obtain data. For example, the baseline for the DCCF service used by an NWDAF consumer to obtain UE mobility data is Namf_EventExposure.

3GPP TS 23.288 (v17.2.0) specifies that NWDAF is the main network function for computing analytics reports. The 5G system architecture allows any NF to obtain analytics from an NWDAF using a DCCF function and associated Ndccf services. The NWDAF can also store and retrieve analytics information from an Analytics Data Repository Function (ADRF).

3GPP TS 23.288 also classifies NWDAF into two sub-functions (or logical functions): NWDAF Analytics Logical Function (NWDAF AnLF), which performs analytics procedures; and NWDAF Model Training Logical Function (NWDAF MTLF), which performs training and retraining of ML models used by NWDAF AnLF. In the following, the terms “AnLF”, “NWDAF AnLF”, and “NWDAF (AnLF)” will be used interchangeably. Likewise, the terms “MTLF”, “NWDAF MTLF”, and “NWDAF (MTLF)”will be used interchangeably.

3GPP TS 23.288 (v17.2.0) specifies a subscribe/notify procedure for a consumer NF to retrieve ML model(s) associated with one or more Analytics IDs whenever a new ML model has been trained by the NWDAF MTLF and becomes available. This is referred to as ML Model Provisioning and is implemented by the Nnwdaf_MLModelProvision service.

3GPP TR 33.738 (v0.2.0) describes a study on security aspects of enablers for network automation for 5G. One of the objectives of the study is security for AI/ML model sharing and storage, which is identified as “Key Issue #3”. The following text from 3GPP TR 33.378 describes various aspects of this issue. In this text, “NFc” refers to a consumer NF and “NFp” refers to a producer NF, from the perspective of an AI/ML of interest.
***Begin 3GPP text***
5.3.1 Issue details
   AI/ML model is shared among NWDAFs and/or NFs (i.e., NWDAF to NWDAF, ADRF to NWDAF . . . ). In different scenarios, the NF producer of AI/ML model can store that model in ADRF, NWDAF or other entity.
   ADRF (Analytical Data Repository Function) is being enhanced to store AI/ML models to facilitate the distribution and sharing of those models amongst NFs. Since AI/ML models and their algorithms are generally proprietary (i.e., subject to intellectual property rights of the designer), it is imperative to ensure that only the NFs which have been indeed provided with access authorization to the AI/ML models can read and use those models. Moreover, the ADRF itself cannot be considered as a fully trusted entity storing the sensitive AI/ML data models. Those models are indeed exposed at rest in ADRF.
   The current authorization scheme defined by 3GPP for SBA works only at service level or resource/operation-level scope. This authorization granularity may be not sufficient in the AI/ML model sharing scenario, since the ADRF (Analytical Data Repository Function) or NWDAF, or any other network function which may store the AI/ML model, cannot verify whether the NF consumer is authorized to retrieve the AI/ML model.
5.3.2 Security Threats
   An unauthorized NFc, in principle which is not eligible to retrieve a particular model stored by a NFp, could have access to the storage entity and retrieve the model.
   If there is no protection against accessing and reading an AI/ML model from the ADRF stored by NFp, a compromised ADRF may expose algorithms and sensitive data to a non-authorized entity which can easily misuse it and/or distributed further to other entities, causing a bigger data security breach.
5.3.3 Potential security requirements
   AI/ML models shall be protected between the entity which produces the ML model or stores the ML model in ADRF (e.g., NWDAF containing MTLF, NFp) and the entity which consumes the model (NFc).
   ADRF (Analytical Data Repository Function), or any other network function which may store the
   AI/ML model, shall be able to authorize the NFc to retrieve that AI/ML model.
   NF Service consumers shall be authorized to access to the AI/ML models in the ADRF (or any other NF which may store the ML model, for instance NWDAF MTLF).
***End 3GPP text**

3GPP TR 33.738 (v0.2.0) also describes a solution for authorization and authentication of AI/ML model transfer, which is identified as “solution #2”. This security solution protects an AI/ML model between a first entity (e.g., NF) that produces the AI/ML model (or stores the AI/ML model in ADRF) and a second entity that consumes the model (NFc). In this solution, an authorization token is used by ADRF to verify that the NFc is allowed to access the ML model.

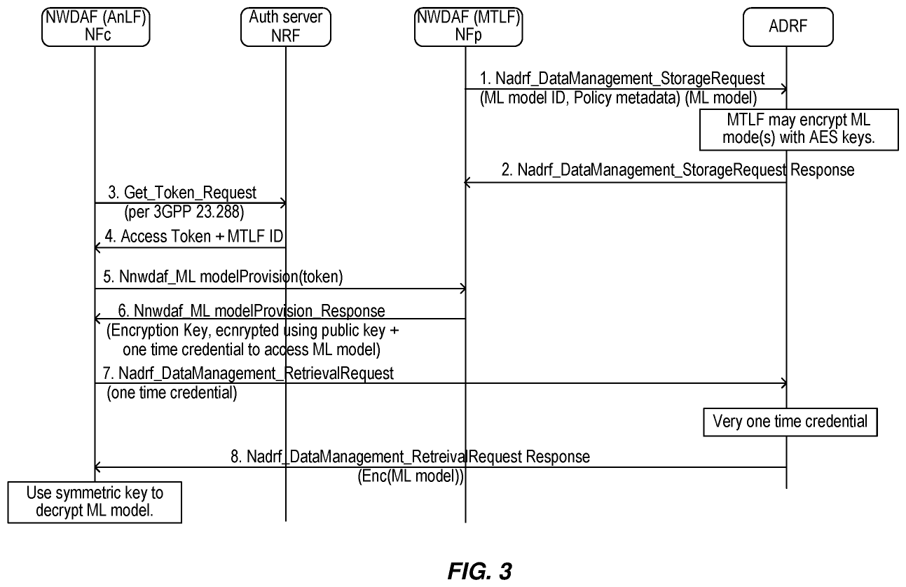

FIG. 3 shows a signaling diagram for this solution for authorization and authentication of AI/ML model transfer. As shown in FIG. 3, the signaling is between an NWDAF(AnLF)/NFc, an authorization server (e.g., NRF), an NWDAF(MTLF)/NFp, and an ADRF. Although the operations shown in FIG. 3 are given numerical labels, this is intended to facilitate explanation rather than to require or imply any specific operational order, unless stated otherwise below.

In operation 1, the MTLF trains the ML model and sends ML Model to the ADRF by invoking the Nadrf_DataManagement StorageRequest (ML Model) service operation. In addition to model metadata, this message can include ML model ID, analytics ID, Vendor ID, MAC or SHA256 Signature of the application binary, environment required for ML model execution, URL/link to retrieve configuration, and secrets/signing key/certificate to generate authentication credentials. MTLF may send an ML model encrypted using a symmetric key (e.g., AES key) before the storage.

In operation 2, ADRF stores the ML model and response as specified in 3GPP TS 23.288 (v17.6.0), except that the storage is performed by the ADRF. In operation 3, the NFc (e.g., NWDAF AnLF) contacts NRF and requests an access token using existing procedures specified in 3GPP TS 33.501 (v17.7.0). In operation 4, NRF sends an access token along with MTLF ID using existing procedures specified in 3GPP TS 23.288.

In operation 5, NWDAF(AnLF) uses Nnwdaf_MLModelProvision service operation with the access token to request the ML model ID from NWDAF(MTLF), which retrieves the ML model ID based on ML analytics ID and/or ADRF ID. NWDAF(MTLF) also verifies received access token. In operation 6, NWDAF(MTLF) sends Nnwdaf_MLModelProvision Response that includes the encryption key used to encrypt the AI/ML model in operation 1. Additionally, the NWDAF(MTLF) can include one-time credentials to access the model from ADRF, including any of the following:
Nonce, which is shared in operation 1 as part of the metadata;
MAC or hash of a binary or random number shared in operation 1 as part of the data;
signing key as a private key of MTLF, with the public part being shared in operation 1;
credentials generated by MTLF's signing key, e.g., a JWT token or a certificate.
   One-time credentials can be used to limit the number of accesses from the NFc. Even so, a “one-time” credential may be used as a regular authorization token for accessing the ML model multiple times, i.e., not only once, as the name suggests.

In operation 7, NWDAF(AnLF) uses the ADRF service procedure to request the ML model, including the one-time credential received in operation 6. In operation 8, ADRF verifies the one-time credential and, if successfully verified, provides the stored AI/ML model to the NWDAF(AnLF).

As mentioned above, AI/ML models are generally considered important intellectual property of their owners (e.g., 5GC vendors) and, as such, need to have their confidentiality and integrity protected at all times. 3GPP is studying the feasibility of sharing or storing AI/ML models in network equipment that may be provided by different vendors. In this arrangement, an AI/ML model should be protected from access and use by consumer NFs that are provided by different vendors than the AI/ML model. Currently, however, there are no specified solutions to this requirement. For example, the solution shown in FIG. 3 does not provide the needed security in a multi-vendor network environment.

Embodiments of the present disclosure address these and other problems, issues, and/or difficulties by providing secure AI/ML model sharing between NFp (e.g., NWDAF MTLF) and NFc (e.g., NWDAF AnLF) and AI/ML model storage in ADRF. For example, the NFp (e.g., NWDAF MTLF) can authorize the transfer and storage of its AI/ML model in an external storage repository (e.g., ADRF), and/or the retrieval of its AI/ML model from the storage repository. As another example, the NFp (e.g., NWDAF MTLF) can authorize the transfer of its AI/ML model to an NFc (e.g., NWDAF AnLF). As another example, the NFp (e.g., NWDAF MTLF) can confidentiality protect its AI/ML model and/or model location information during the transfer scenarios mentioned above.

Embodiments of the present disclosure can provide various benefits and/or advantages. By providing the AI/ML model owner/producer the capability to protect the AI/ML model during various transfer, storage, and retrieval scenarios, embodiments improve the security of confidential and/or sensitive AI/ML models and thereby facilitate deployment of such models in a multi-vendor communication network, such as 5GC.

In the following descriptions of various embodiments, the terms NFp and NWDAF(MTLF) may be used interchangeably, and the terms NFc and NWDAF(AnLF) may be used interchangeably. Similarly, the terms “model”, “ML model”, and “AI/ML model” may be used interchangeably.

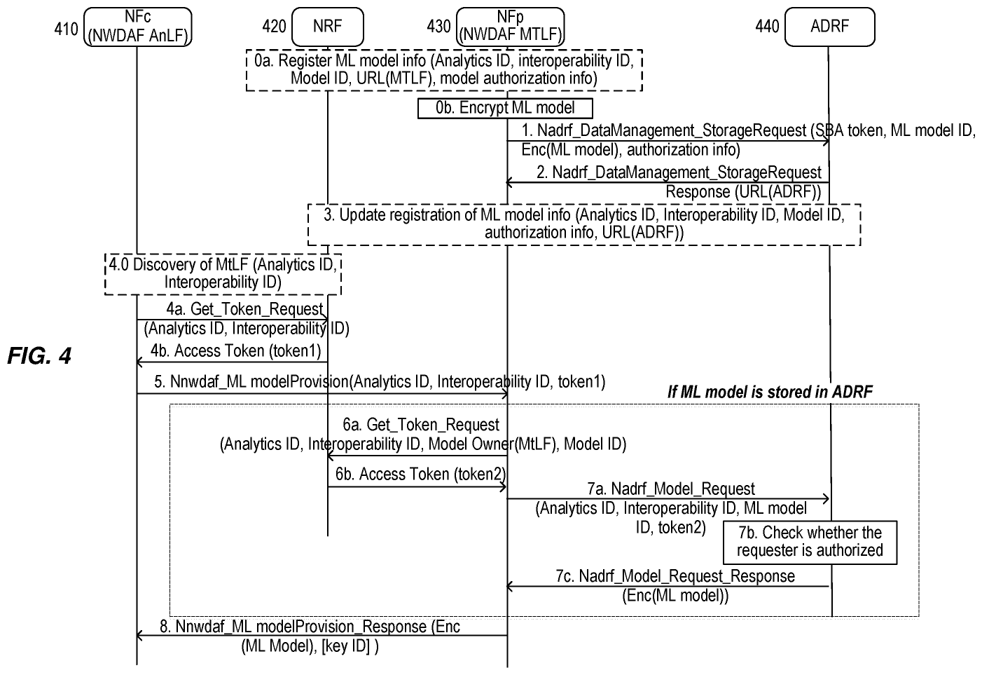

FIG. 4 shows a signaling diagram of a procedure involving an NWDAF(AnLF) (410), an NRF (420), an NWDAF(MTLF) (430), and an ADRF (440), according to some embodiments of the present disclosure. Although the operations shown in FIG. 4 are given numerical labels, this is intended to facilitate explanation rather than to require or imply any specific operational order, unless stated otherwise below.

In operation 0, NWDAF(MTLF) trains the ML model and may encrypt it and protect its integrity. The keys for protection may referred by Key ID or certificate, and are bound with Interoperability ID, ML model ID, analytics ID, Vendor ID, etc. It is assumed that NFs authorized for the same Interoperability ID, ML model ID, analytics ID, Vendor ID, etc. are provisioned with the corresponding keys for encryption/decryption/validation.

Additionally, NWDAF(MTLF) registers its NF profile in NRF with the ML model information, which can include Analytics ID, Interoperability ID, Vendor ID, ML model filter, Model URL, Model ID, and model authorization information. The model authorization information specifies scope of authorization for access to the ML model, such as requester, provider, model owner, and target model information. As a more specific example:
Target models are identified by: Interoperability ID, Vendor ID, Analytics ID, model owner, model filter, model URL, model ID; and
Scope is identified by: allowed requester and/or provider NF type/ID, allowed requester and/or provider vendor ID(s), allowed interoperability ID(s) etc.

In operation 1, NWDAF(MTLF) sends the trained ML model to the ADRF for storage by invoking Nadrf_DataManagement_StorageRequest service operation. NWDAF(MTLF) includes in this message an SBA token, the encrypted ML model, one or more model identifiers (e.g., ML model ID, analytics ID, vendor ID, etc) and optionally model authorization information to facilitate subsequent access to the model. In operation 2, ADRF stores the encrypted ML model and responds with a URL corresponding to a storage location of the ML model file (i.e., in ADRF). In operation 3, NWDAF(MTLF) updates its NF profile in NRF with the ML model information received from ADRF (e.g., URL).

In some variants, ADRF may register the model authorization information (similar context as operation 9) in its own NF profile in NRF. In other variants, NWDAF(MTLF) may register the model authorization info (similar context as operation 0) in the ADRF's NF profile in NRF, i.e., on behalf of ADRF.

In operation 4, NWDAF(AnLF) discovers the NWDAF(MTLF) using existing procedures specified in 3GPP TS 23.288. In operation 4a, NWDAF(AnLF) contacts NRF to request an access token (“token1”) using existing procedures specified in 3GPP TS 33.501. In operation 4b, NRF provides token1 to NWDAF(AnLF) according to these procedures.

In operation 5, NWDAF(AnLF) uses Nnwdaf_MLModelProvision or Nnwdaf MLModelInfo_Request service operation with the access token (token1) received in operation 4 to retrieve the ML model. If NWDAF(MTLF) stores the model locally, it performs operation 8 described below. If the model is stored in ADRF, operations 6-7 are performed after operation 5.

In operation 6a, NWDAF(MTLF) requests from NRF a token for accessing the ML model by providing analytics ID, interoperability ID, ML model ID, model owner information (e.g., MTLF ID), etc. In operation 6b, NRF verifies that NWDAF(MTLF) is authorized to access the requested ML model according to the model authorization information previously registered in NRF (e.g., operations 0, 3) and, if so, generates a second access token (“token2”) and sends it to NWDAF(MTLF).

In operation 7a NWDAF(MTLF) requests the ML model from ADRF using Nadrf Model_Request service operation, and includes analytics ID, interoperability ID, ML model ID, and token2. In operation 7b, ADRF verifies that NWDAF(MTLF) is authorized to retrieve the ML model based on the received token2 or the ML model authorization information received in operation 1. If verified, in operation 7c ADRF sends the encrypted ML model to NWDAF(MTLF).

In operation 8, NWDAF(MTLF) sends the ML model to the NWDAF(AnLF) using Nnwdaf_MLModelProvision Response, according to the service used to request in operation 5. In this operation, the ML model may still be encrypted (as received in operation 7c) or may be unencrypted by NWDAF(MTLF) and sent in clear. If the ML Model is sent encrypted, NWDAF(MTLF) may include information to help NWDAF(AnLF) locate keys for decryption/validation (e.g., ID, certificate, or certificate URL associated with keys used to protect the ML model).

In some variants, ML model information is obtained via URL in a similar manner as shown in FIG. 4, but with different services, messages, and/or protocols. The signaling flow for these embodiments is the same as shown in FIG. 4, but other downloading services, messages, and/or protocols can be used in operations 1b/c and 6-9. For example, the ML model can be obtained by URL via an unspecified procedure that is assumed to be vendor implementation specific.

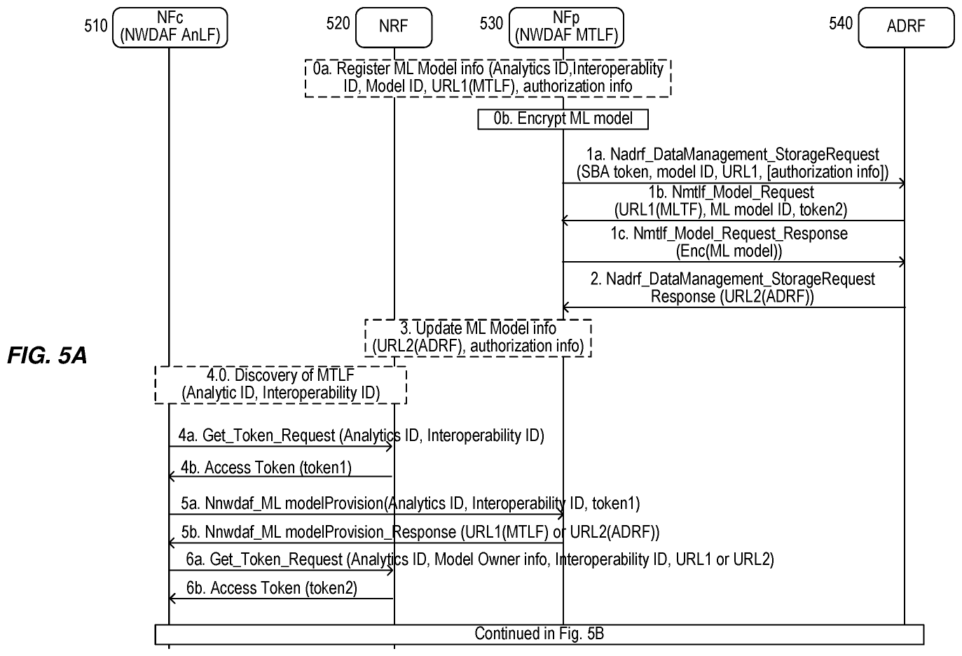

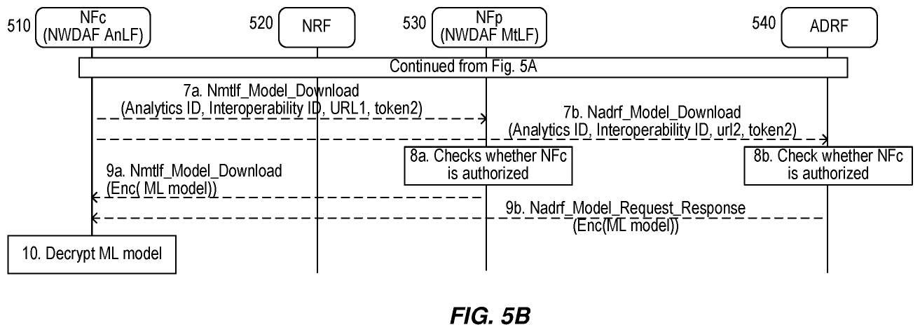

FIG. 5 (which includes FIGS. 5A-B) shows a signaling diagram of another procedure involving an NWDAF(AnLF) (510), an NRF (520), an NWDAF(MTLF) (530), and an ADRF (540), according to other embodiments of the present disclosure. Although the operations shown in FIG. 5 are given numerical labels, this is intended to facilitate explanation rather than to require or imply any specific operational order, unless stated otherwise below.

Operation 0a-b are identical to corresponding operations in FIG. 4, described above. In operation 1a, instead of sending the encrypted ML model as in FIG. 4 operation 1, NWDAF(MTLF) sends to ADRF a URL (“URL1”) of where the ML model is stored and from which it can be obtained. In operation 1b, ADRF uses an Nmtlf_Model_Request service operation to send URL1, ML model ID, and an access token (“token2”) to obtain/fetch the ML model. In some variants, ADRF may also include an analytics ID and/or an interoperability ID. In operation 1c, NWDAF(MTLF) provides the ML model in a response, based on verifying the access token.

In different variants of operation 1a, URL1 may be sent in clear text or in encrypted form. In case it is encrypted, NWDAF(MTLF) may include in the message information to assist ADRF to locate keys for decryption/validation (e.g., ID, certificate, or certificate URL associated with keys used to protect URL1).

Although not shown in FIG. 5, ADRF can obtain token2 from NRF in a similar manner as NWDAF(AnLF) obtains token1 from NRF in operations 6a-b, described below. When issuing token2, NRF checks that ADRF can fetch the ML model from URL based on the model authorization information registered in operation 0.

Operations 2-5a are identical to corresponding operations in FIG. 4, described above. In operation 5b, NWDAF(MTLF) sends an address of the ML model to NWDAF(AnLF) using the Nnwdaf_MLModelProvision Response service operation. For example, the address can be URL1, corresponding to the encrypted model stored in NWDAF(MTLF), or URL2, corresponding to the encrypted model stored in the ADRF. In some variants, NWDAF(MTLF) may include information to help NWDAF(AnLF) locate keys for decryption/validation of the ML model (e.g., ID, certificate, or certificate URL associated with keys used to protect the ML model).

In different variants of operation 5b, URL1/URL2 may be sent in clear text or in encrypted form. In case it is encrypted, NWDAF(MTLF) may include in the message information to assist NWDAF(AnLF) to locate keys for decryption/validation (e.g., ID, certificate, or certificate URL associated with keys used to protect URL1/URL2).

In operation 6a, NWDAF(AnLF) requests from NRF a token for accessing ML model via URL (e.g., downloading service). The request includes an analytics ID, interoperability ID, Model Owner information (e.g., MTLF ID), URL1 or ULR2 received in operation 5b. In operation 6b, NRF verifies that NWDAF(AnLF) is authorized to access the ML model according to the model authorization information registered in NRF (e.g., operations 0a, 3) and issues token2.

If URL1 is received in operation 5b, then operations 7a, 8a, and 9a are performed. In operation 7a, NWDAF(AnLF) invokes the Nmtlf_Model Download service operation to download the ML model from NWDAF(MTLF), providing the analytics ID, interoperability ID, URL1, and token2. In operation 8a, NWDAF(MTLF) verifies that NWDAF(AnLF) is authorized to retrieve the ML model, based on received token2 or local ML model authorization. In operation 9a, based on the verification, NWDAF(MTLF) sends the encrypted ML model to NWDAF(MTLF), in a similar manner as operation 8 in FIG. 4.

If URL2 is received in operation 5b, then operations 7b, 8b, and 9b are performed. In operation 7b, NWDAF(AnLF) invokes the Nadrf_Model Download service operation to download the ML model from ADRF, providing the analytics ID, interoperability ID, URL2, and token2. In operation 8b, NWDAF(AnLF) is authorized to retrieve the ML model, based on received token2 or the model authorization information received in operation 1. In operation 9b, based on the verification, ADRF sends the encrypted ML model to NWDAF(MTLF), in a similar manner as operation 8 in FIG. 4.

In some variants, a different protocol (e.g., FTP) can be used instead of any of service-based interfaces (SBI) used in operations 1b/c, 7a/c, and 9a/c of FIG. 5.

In some variants, instead of discovering NWDAF(MTLF) in operation 4, NWDAF(AnLF) discovers ADRF via NRF based on interoperability ID, ML model ID, analytics ID, vendor ID, etc. In such case, NWDAF(AnLF) can obtain address (e.g., URL or FQDN) of ML model directly from ADRF.

For example, in operations 4a-b, NWDAF(AnLF) requests and receives an SBA token (token1) to access ADRF. In this case, operations 5a-b are not performed and in operations 6a-b, NWDAF(AnLF) requests and receives an access token (token2) for ML model downloading from ADRF, e.g., via URL2. Note that token2 can be identical to token 1 in these variants. Furthermore, URL2 may be provided in operation 6b in clear text or in encrypted form, in a similar manner as described above.

In some variants of the embodiments illustrated by FIG. 4-5, if NWDAF(AnLF) wants to receive updates of the ML model by NWDAF(MTLF), NWDAF(AnLF) subscribes for model updates based on interoperability ID, ML model ID, analytics ID, Vendor ID, etc. If the model is updated, NWDAF(MTLF) may use different key(s) for encryption and integrity protection of the updated model than used for the previous model version. In case the updated model is retrieved from NWDAF(MTLF), that entity can provide information to assist NWDAF(AnLF) to locate keys for decryption/validation (e.g., ID, certificate, or certificate URL associated with keys used to protect updated model).

Alternately, if the updated model is retrieved from ADRF by NWDAF(AnLF), NFp notifies NWDAF(AnLF) with model ID, URL, and/or FQDN, optionally including new key ID, etc. in a similar manner operation 5b discussed above. NWDAF(AnLF) fetches the encrypted updated ML model from ADRF and performs decryption and integrity check using the new keys identified by NWDAF(MTLF).

Although embodiments have been described above in the specific context of an NWDAF and its logical functions MTLF and AnLF, skilled persons will understand that underlying principles of the above-described embodiments are equally applicable to other NFs, logical functions, nodes, etc. that may be called different names but perform similar operations as MTLF and AnLF.

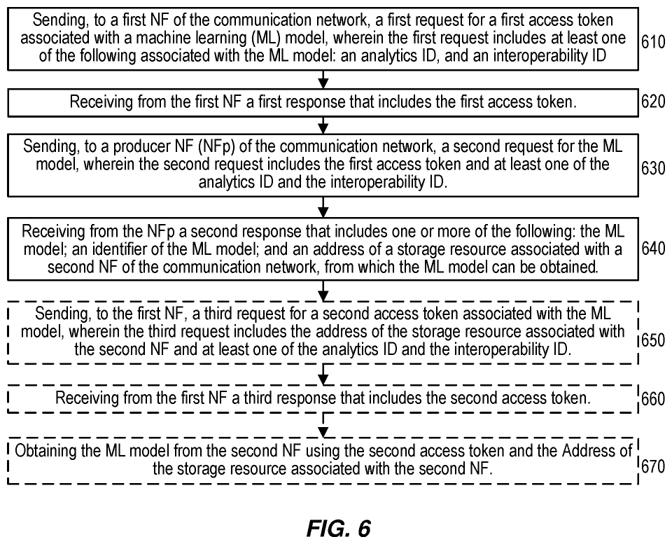

These embodiments described above can be further illustrated with reference to FIGS. 6-9, which depict exemplary methods (e.g., procedures) for a consumer NF, a producer NF, an NRF, and an ADRF, respectively. Put differently, various features of the operations described below correspond to various embodiments described above. The exemplary methods shown in FIGS. 6-9 can be used cooperatively (e.g., with each other and with other procedures described herein) to provide benefits, advantages, and/or solutions to problems described herein. Although the exemplary methods are illustrated in FIGS. 6-9 by specific blocks in particular orders, the operations corresponding to the blocks can be performed in different orders than shown and can be combined and/or divided into blocks and/or operations having different functionality than shown. Optional blocks and/or operations are indicated by dashed lines.

More specifically, FIG. 6 illustrates an exemplary method (e.g., procedure) for a consumer NF (NFc) of a communication network (e.g., 5GC), according to various embodiments of the present disclosure. The exemplary method shown in FIG. 6 can be performed by an NFc such as an NWDAF (AnLF) or a network node hosting an NWDAF (AnLF), such as described elsewhere herein.

The exemplary method can include the operations of block 610, where the NFc can send, to a first NF of the communication network, a first request for a first access token associated with an ML model. The first request includes one or more of the following associated with the ML model: an analytics ID, and an interoperability ID. The exemplary method can also include the operations of block 620, where the NFc can receive from the first NF a first response that includes the first access token. The exemplary method can also include the operations of block 630, where the NFc can send to a producer NF (NFp) of the communication network a second request for the ML model. The second request includes the first access token and at least one of the analytics ID and the interoperability ID. The exemplary method can also include the operations of block 640, where the NFc can receive from the NFp a second response that includes one or more of the following: the ML model, an identifier of the ML model, and an address of a storage resource associated with a second NF of the communication network, from which the ML model can be obtained.

In some embodiments, first NF is a network repository function (NRF). In other embodiments, the first NF is an analytics data repository function (ADRF). In some embodiments, one or more of the following applies:
the NFc is an analytics logical function of a network data analytics function, NWDAF (AnLF); and
the NFp is a model training logical function of the network data analytics function, NWDAF (MTLF).

In some embodiments, the second response includes the ML model (e.g., as illustrated in FIG. 4), which can be encrypted. In such case, the second response also includes information usable to locate keys that can be used for decryption and validation of the ML model. Some examples of such information were discussed above.

In other embodiments, the second response includes the address of the storage resource associated with the ML model (e.g., as illustrated in FIG. 5) and the exemplary method also includes the following operations, labelled with corresponding block numbers:
(650) sending, to the first NF, a third request for a second access token associated with the ML model, wherein the third request includes the address of the storage resource associated with the second NF and at least one of the analytics ID and the interoperability ID;
(660) receiving from the first NF a third response that includes the second access token; and
(670) obtaining the ML model from the second NF using the second access token and the address of the storage resource associated with the second NF.

In some of these embodiments, the address of the storage resource is encrypted and the second response also includes information usable to locate keys that can be used for decryption and validation of the address of the storage resource.

In some embodiments, the address of the storage resource associated with the second NF is a universal resource locator (URL). In other embodiments, the address of the storage resource associated with the second NF is a fully qualified domain name (FQDN). In some embodiments, the second NF is the NFp. In other embodiments, the second NF is an ADRF.

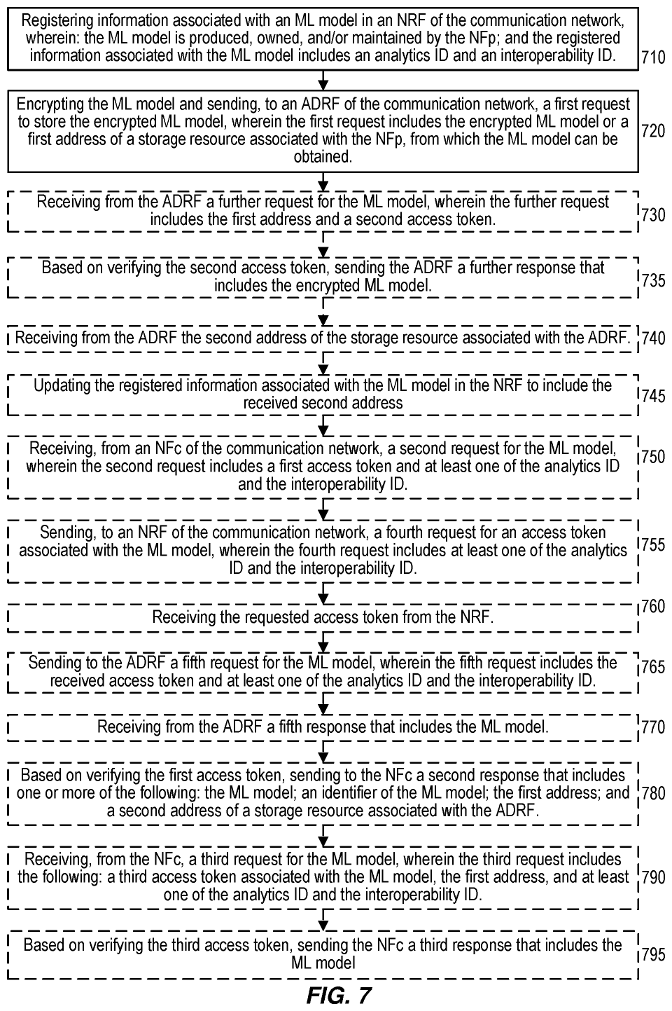

In addition, FIG. 7 illustrates an exemplary method (e.g., procedure) for an NFp of a communication network (e.g., 5GC), according to various embodiments of the present disclosure. The exemplary method shown in FIG. 7 can be performed by an NFp such as an NWDAF (MTLF) or a network node hosting an NWDAF (MTLF), such as described elsewhere herein.

The exemplary method includes the operations of block 710, where the NFp can register information associated with an ML model in an NRF of the communication network. The ML model is produced, owned, and/or maintained by the NFp, with the “and/or” indicating any one or more of the three listed properties. The registered information associated with the ML model includes an analytics ID and an interoperability ID. The exemplary method also includes the operations of block 720, where the NFp can encrypt the ML model and send to an ADRF of the communication network a first request to store the encrypted ML model. The first request includes the encrypted ML model or a first address of a storage resource associated with the NFp, from which the ML model can be obtained.

In some embodiments, the exemplary method can also include the operations of block 750, where the NFp can receive, from an NFc of the communication network, a second request for the ML model. The second request includes a first access token and at least one of the analytics ID and the interoperability ID. The exemplary method can also include the operations of block 780, where based on verifying the first access token, the NFp can send to the NFc a second response that includes one or more of the following: the ML model; an identifier of the ML model; the first address of the storage resource associated with the NFp; and a second address of a storage resource associated with the ADRF, from which the ML model can be obtained.

In some of these embodiments, the first address of the storage resource associated with the NFp is a first universal resource locator (URL) and the second address of the storage resource associated with the ADRF is a second URL or a fully qualified domain name (FQDN).

In some of these embodiments, the first request includes the first address of the storage resource associated with the NFp and the second response includes one of the following:
the first address of the storage resource associated with the NFp, or
the second address of the storage resource associated with the ADRF.
   FIG. 5 shows an example of these embodiments.

In some variants of these embodiments, the first address included in the first request is encrypted, and the first request also includes information usable to locate keys that can be used for decryption and validation of the first address. In some variants of these embodiments, the first or second address included in the second response is encrypted, and the second response also includes information usable to locate keys that can be used for decryption and validation of the first or second address.

In some further variants, the exemplary method can also include the following operations, labelled with corresponding block numbers:
(730) receiving from the ADRF a further request for the ML model, wherein the further request includes a second access token and the first address of the storage resource associated with the NFp;
(735) based on verifying the second access token, sending the ADRF a further response that includes the encrypted ML model; and
(740) subsequently receiving from the ADRF the second address of the storage resource associated with the ADRF.

In some further variants, the registered information associated with the ML model (e.g., from block 710) also includes the first address of the storage resource associated with the NFp, and the exemplary method also includes the operations of block 745, where the NFp can update the registered information associated with the ML model in the NRF to include the received second address.

In some variants of these embodiments, the second response includes the first address of the storage resource associated with the NFp and the exemplary method also includes the following operations, labelled with corresponding block numbers:
(790) receiving, from the NFc, a third request for the ML model, wherein the third request includes the following: a third access token associated with the ML model, the first address, and at least one of the analytics ID and the interoperability ID; and
(795) based on verifying the third access token, sending the NFc a third response that includes the ML model.
   In some further variants, the ML model in the third response is encrypted and the third response also includes information usable to locate keys that can be used for decryption and validation of the ML model.

In other of these embodiments, the exemplary method can also include the following operations, labelled with corresponding block numbers:
(755) sending, to an NRF of the communication network, a fourth request for an access token associated with the ML model, wherein the fourth request includes at least one of the analytics ID and the interoperability ID;
(760) receiving the requested access token from the NRF;
(765) sending to the ADRF a fifth request for the ML model, wherein the fifth request includes the received access token and at least one of the analytics ID and the interoperability ID;
(770) receiving from the ADRF a fifth response that includes the ML model.
   The received ML model is then included in the second response sent to the NFc (e.g., in block 780).

In some embodiments, the NFc is an NWDAF (anlf). In some embodiments, the NFp is an NWDAF (MTLF).

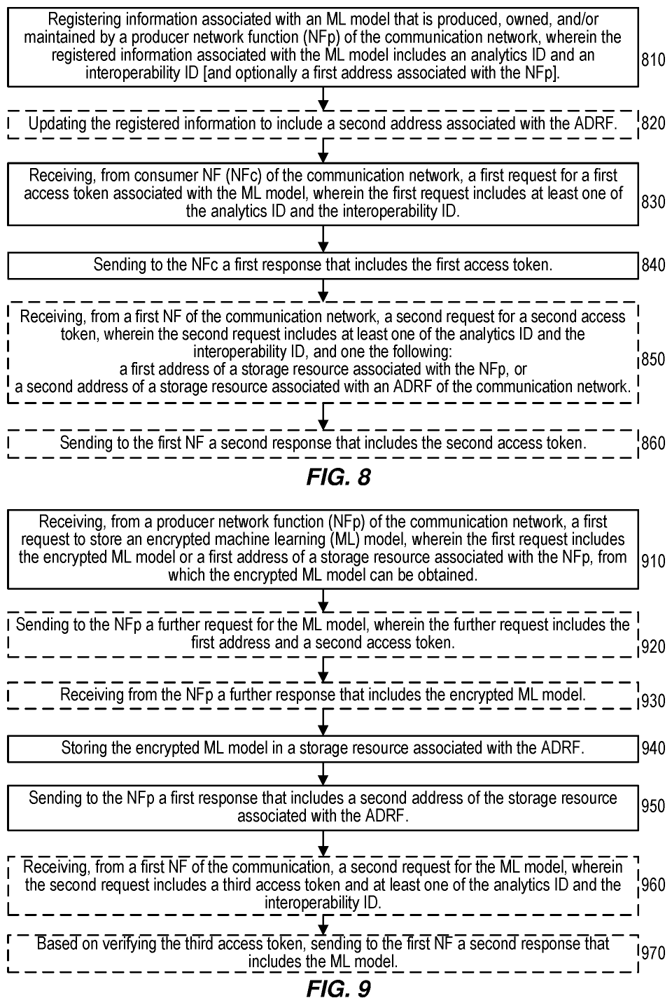

In addition, FIG. 8 illustrates an exemplary method (e.g., procedure) for an NRF of a communication network (e.g., 5GC), according to various embodiments of the present disclosure. The exemplary method shown in FIG. 8 can be performed by an NRF or a network node hosting an NRF, such as described elsewhere herein.

The exemplary method includes the operations of block 810, where the NRF can register information associated with an ML model that is produced, owned, and/or maintained by a producer network function (NFp) of the communication network, with the “and/or” indicating any one or more of the three listed properties. The registered information associated with the ML model includes an analytics ID and an interoperability ID. The exemplary method also includes the operations of block 830, where the NRF can receiving, from an NFc of the communication network, a first request for a first access token associated with the ML model. The first request includes at least one of the analytics ID and the interoperability ID. The exemplary method also includes the operations of block 840, where the NRF can send to the NFc a first response that includes the first access token.

In some embodiments, the exemplary method also includes the operations of block 850, where the NRF can receive, from a first NF of the communication network, a second request for a second access token. The second request includes at least one of the analytics ID and the interoperability ID, and one of the following:
a first address of a storage resource associated with the NFp, from which the ML model can be obtained; or
a second address of a storage resource associated with an ADRF of the communication network, from which the ML model can be obtained.
   The exemplary method can also include the operations of block 860, where the NRF can send to the first NF a second response that includes the second access token.

In some of these embodiments, the first address of the storage resource associated with the NFp is a first URL and the second address of a storage resource associated with the ADRF is a second URL or an FQDN. In some of these embodiments, the first NF is the NFc (e.g., as illustrated in FIG. 5). In other of these embodiments, the first NF is the NFp (e.g., as illustrated in FIG. 4).

In some of these embodiments, the registered information associated with the ML model (e.g., in block 810) also includes the first address of the storage resource associated with the NFp and the exemplary method also includes the operations of block 820, where the NRF can update the registered information to include the second identifier of the storage resource associated with the ADRF, e.g., based on request of the NFp.

In some embodiments, the NFc is an NWDAF (AnLF). In some embodiments, the NFp is an NWDAF (MTLF).

In addition, FIG. 9 illustrates an exemplary method (e.g., procedure) for an ADRF of a communication network (e.g., 5GC), according to various embodiments of the present disclosure. The exemplary method shown in FIG. 9 can be performed by an ADRF or a network node hosting an ADRF, such as described elsewhere herein.

The exemplary method includes the operations of block 910, where the ADRF can receive, from an NFp of the communication network, a first request to store an encrypted ML model. The first request includes the encrypted ML model or a first address of a storage resource associated with the NFp, from which the encrypted ML model can be obtained. The exemplary method also includes the operations of block 940, where the ADRF can store the encrypted ML model in a storage resource associated with the ADRF. The exemplary method also includes the operations of block 950, where the ADRF can send to the NFp a first response that includes a second address of the storage resource associated with the ADRF.

In some embodiments, the first request includes the first address of the storage resource associated with the NFp and the exemplary method also includes the operations of block 920, where the ADRF can send to the NFp a further request for the ML model. The further request includes the first address and a second access token. The exemplary method also includes the operations of block 930, where the ADRF can receive from the NFp a further response that includes the encrypted ML model. The encrypted model is then stored in the storage resource associated with the ADRF (e.g., in block 940). FIG. 5 shows an example of these embodiments.

In other embodiments, the exemplary method also includes the operations of block 960, where the ADRF can receive from a first NF of the communication a second request for the ML model. The second request includes a third access token and at least one of the analytics ID and the interoperability ID. The exemplary method can also include the operations of block 970, where based on verifying the third access token, the ADRF can send to the first NF a second response that includes the ML model.

In some of these embodiments, the first NF is the NFp (e.g., as illustrated in FIG. 4). In other of these embodiments, the first NF is an NFc of the communication network (e.g., as illustrated in FIG. 5). In some variants of these embodiments, the NFc is an NWDAF (AnLF) and/or the NFp is an NWDAF (MTLF).

In some of these embodiments, the ML model included in the second response (e.g., in block 970) is encrypted and the second response also includes information usable to locate keys that can be used for decryption and validation of the ML model.

In some embodiments, the first address of the storage resource associated with the NFp is a first URL and the second address of a storage resource associated with the ADRF is a second URL or an FQDN.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

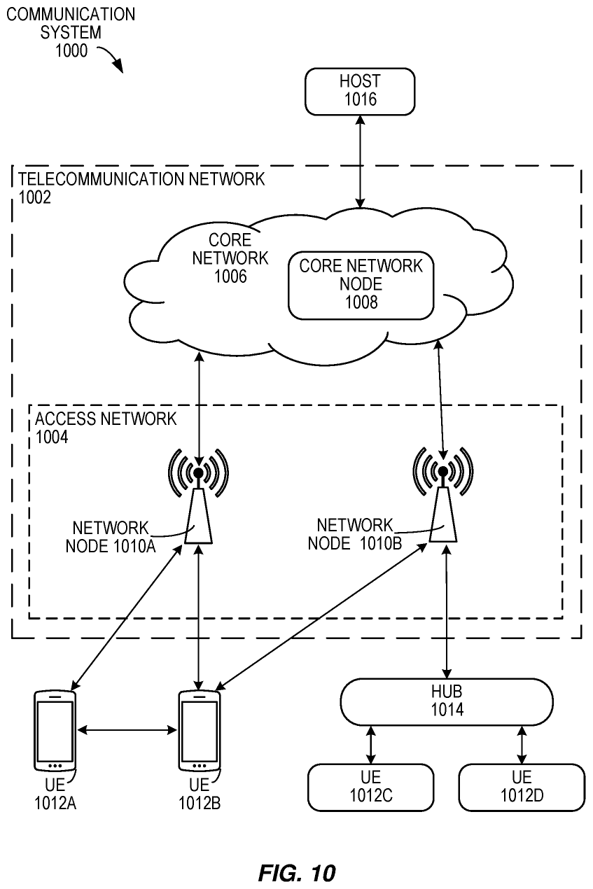

FIG. 10 shows an example of a communication system 1000 in accordance with some embodiments. In this example, communication system 1000 includes a telecommunication network 1002 that includes access network 1004 (e.g., RAN) and core network 1006, which includes one or more core network nodes 1008. Access network 1004 includes one or more access network nodes, such as network nodes 1010a-b (one or more of which may be generally referred to as network nodes 1010), or any other similar 3GPP access node or non-3GPP access point. Network nodes 1010 facilitate direct or indirect connection of UEs, such as by connecting UEs 1012a-d (one or more of which may be generally referred to as UEs 1012) to core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, core network 1006 connects network nodes 1010 to one or more hosts, such as host 1016. These connections may be direct or indirect via one or more intermediary networks or devices. In other examples, network nodes may be directly coupled to hosts. Core network 1006 includes one or more core network nodes (e.g., 1008) that are structured with hardware and software components. Features of these components may be substantially similar to those described with respect to the UEs, network nodes, and/or hosts, such that the descriptions thereof are generally applicable to the corresponding components of core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to access network 1004 on a predetermined schedule, when triggered by an internal or external event, or in response to requests from access network 1004. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, hub 1014 communicates with access network 1004 to facilitate indirect communication between one or more UEs (e.g., UE 1012c and/or 1012d) and network nodes (e.g., network node 1010b). In some examples, hub 1014 may be a controller, router, content source and analytics, or any of the other communication devices described herein regarding UEs. For example, hub 1014 may be a broadband router enabling access to core network 1006 for the UEs. As another example, hub 1014 may be a controller that sends commands or instructions to one or more actuators in the UEs. Commands or instructions may be received from the UEs, network nodes 1010, or by executable code, script, process, or other instructions in hub 1014. As another example, hub 1014 may be a data collector that acts as temporary storage for UE data and, in some embodiments, may perform analysis or other processing of the data. As another example, hub 1014 may be a content source. For example, for a UE that is a VR headset, display, loudspeaker or other media delivery device, hub 1014 may retrieve VR assets, video, audio, or other media or data related to sensory information via a network node, which hub 1014 then provides to the UE either directly, after performing local processing, and/or after adding additional local content. In still another example, hub 1014 acts as a proxy server or orchestrator for the UEs, in particular if one or more of the UEs are low energy IoT devices.

Hub 1014 may have a constant/persistent or intermittent connection to network node 1010b. Hub 1014 may also allow for a different communication scheme and/or schedule between hub 1014 and UEs (e.g., 1012c and/or 1012d), and between hub 1014 and core network 1006. In other examples, hub 1014 is connected to core network 1006 and/or one or more UEs via a wired connection. Moreover, hub 1014 may be configured to connect to an M2M service provider over access network 1004 and/or to another UE over a direct connection. In some scenarios, UEs may establish a wireless connection with network nodes 1010 while still connected via hub 1014 via a wired or wireless connection. In some embodiments, hub 1014 may be a dedicated hub-that is, a hub whose primary function is to route communications to/from the UEs from/to network node 1010b. In other embodiments, hub 1014 may be a non-dedicated hub—that is, a device which is capable of operating to route communications between the UEs and network node 1010b, but which is additionally capable of operating as a communication start and/or end point for certain data channels.

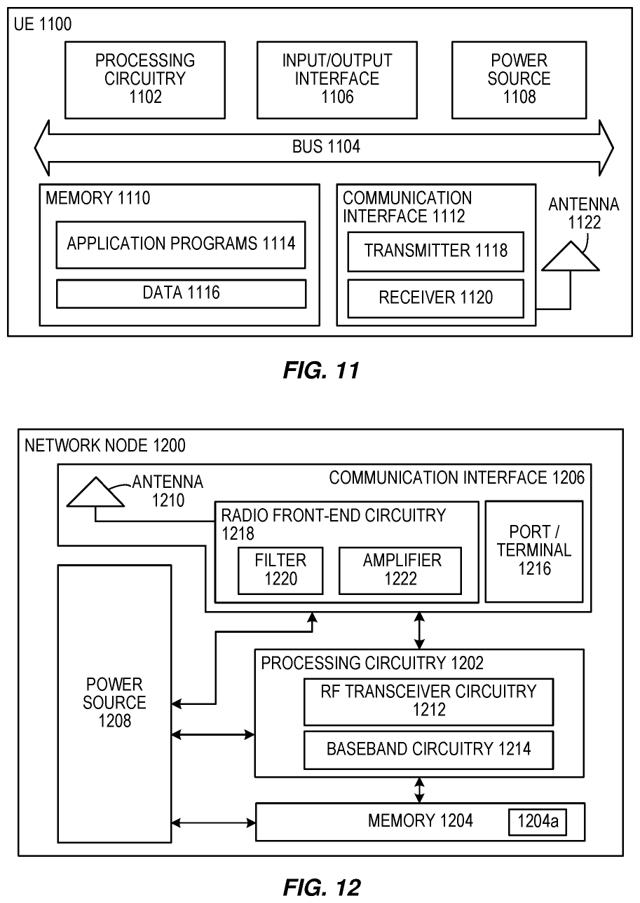

FIG. 11 shows a UE 1100 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1100 includes processing circuitry 1102 that is operatively coupled via bus 1104 to input/output interface 1106, power source 1108, memory 1110, communication interface 1112, and possibly other components not explicitly shown. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

Processing circuitry 1102 is configured to process instructions and data and may be configured to implement any sequential state machine operative to execute instructions stored as machine-readable computer programs in memory 1110. Processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1102 may include multiple central processing units (CPUs).

In the example, input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1108 is structured as a battery or battery pack. Other types of power sources, such as an external power source (e.g., an electricity outlet), photovoltaic device, or power cell, may be used. Power source 1108 may further include power circuitry for delivering power from power source 1108 itself, and/or an external power source, to the various parts of UE 1100 via input circuitry or an interface such as an electrical power cable. Delivering power may be, for example, for charging power source 1108. Power circuitry may perform any formatting, converting, or other modification to the power from power source 1108 to make the power suitable for the respective components of UE 1100 to which power is supplied.

Memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1110 includes one or more application programs 1114, such as an operating system, web browser application, a widget, gadget engine, or other application, and corresponding data 1116. Memory 1110 may store, for use by UE 1100, any of a variety of various operating systems or combinations of operating systems.

Memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1110 may allow UE 1100 to access instructions, application programs and the like, stored on transitory or non-transitory memory media, to off-load data, or to upload data. An article of manufacture, such as one utilizing a communication system may be tangibly embodied as or in memory 1110, which may be or comprise a device-readable storage medium.

Processing circuitry 1102 may be configured to communicate with an access network or other network using communication interface 1112. Communication interface 1112 may comprise one or more communication subsystems and may include or be communicatively coupled to an antenna 1122. Communication interface 1112 may include one or more transceivers used to communicate, such as by communicating with one or more remote transceivers of another device capable of wireless communication (e.g., another UE or a network node in an access network). Each transceiver may include transmitter 1118 and/or receiver 1120 appropriate to provide network communications (e.g., optical, electrical, frequency allocations, and so forth). Moreover, transmitter 1118 and/or receiver 1120 may be coupled to one or more antennas (e.g., 1122) and may share circuit components, software, or firmware, or alternatively be implemented separately.

In the illustrated embodiment, communication functions of communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1100 shown in FIG. 11.

As another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. The UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

For example, one or more network nodes 1200 can be configured to perform operations attributed to an NWDAF (or logical functions thereof) in the descriptions herein of various methods or procedures. As a more specific example, the one or more network nodes 1200 can be configured to perform operations attributed to a consumer NF (e.g., NWDAF AnLF), a producer NF (e.g., NWDAF MTLF), an NRF, and an ADRF.

Network node 1200 includes processing circuitry 1202, memory 1204, communication interface 1206, and power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

Processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as memory 1204, to provide network node 1200 functionality.

In some embodiments, processing circuitry 1202 includes a system on a chip (SOC). In some embodiments, processing circuitry 1202 includes radio frequency (RF) transceiver circuitry 1212 and/or baseband processing circuitry 1214. In some embodiments, RF transceiver circuitry 1212 and/or baseband processing circuitry 1214 may be on separate chips (or sets of chips), boards, or units, such as radio units and digital units. In alternative embodiments, part or all of RF transceiver circuitry 1212 and/or baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1202. Memory 1204 may store any suitable instructions, data, or information, including a computer program, software, an application including one or more of logic, rules, code, tables, and/or other instructions capable of being executed by processing circuitry 1202 and utilized by network node 1200. Memory 1204 may be used to store any calculations made by processing circuitry 1202 and/or any data received via communication interface 1206. In some embodiments, processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to an antenna 1210 and processing circuitry 1202. The radio front-end circuitry may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210 may collect radio signals which are then converted into digital data by radio front-end circuitry 1218. The digital data may be passed to processing circuitry 1202. In other embodiments, the communication interface may comprise different components and/or different combinations of components.

In certain alternative embodiments, network node 1200 does not include separate radio front-end circuitry 1218, instead, processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

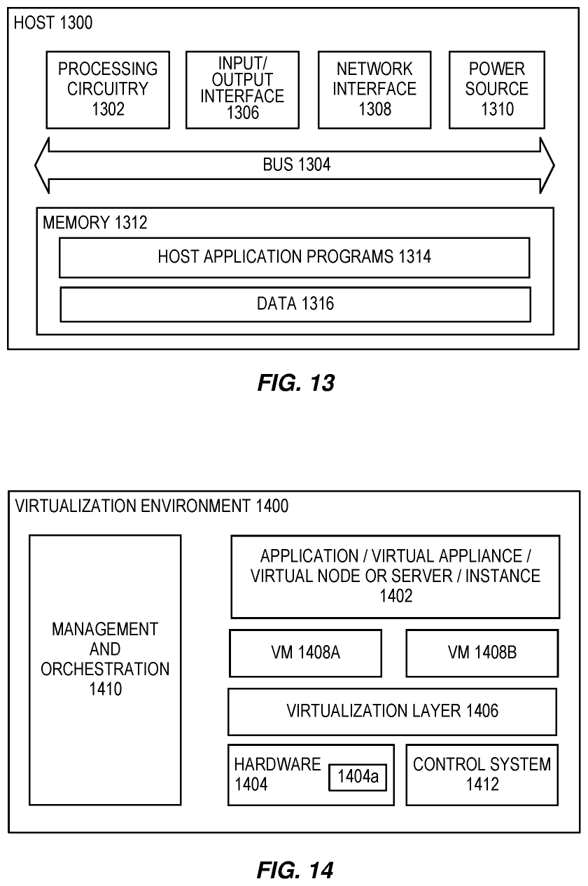

FIG. 13 is a block diagram of a host 1300, which may be an embodiment of host 1016 of FIG. 10, in accordance with various aspects described herein. As used herein, host 1300 may be or comprise various combinations hardware and/or software, including a standalone server, a blade server, a cloud-implemented server, a distributed server, a virtual machine, container, or processing resources in a server farm. Host 1300 may provide one or more services to one or more UEs.

Host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

Memory 1312 may include one or more computer programs including one or more host application programs 1314 and data 1316, which may include user data, e.g., data generated by a UE for host 1300 or data generated by host 1300 for a UE. Embodiments of host 1300 may utilize only a subset or all of the components shown. Host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1314 may also provide for user authentication and licensing checks and may periodically report health, routes, and content availability to a central node, such as a device in or on the edge of a core network. Accordingly, host 1300 may select and/or indicate a different host for over-the-top services for a UE. Host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in virtualization environment 1400 to implement some of the features, functions, and/or benefits of some of the embodiments disclosed herein.

For example, various NFs (or portions thereof) described herein in relation to other figures can be implemented as virtual network functions 1402 in virtualization environment 1400. As a more specific example, a consumer NF (e.g., NWDAF AnLF), a producer NF (e.g., NWDAF MTLF), an NRF, and/or an ADRF can be implemented as virtual network functions 1402 in virtualization environment 1400.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a-b (one or more of which may be generally referred to as VMs 1408), and/or perform any of the functions, features and/or benefits described in relation with some embodiments described herein. The virtualization layer 1406 may present a virtual operating platform that appears like networking hardware to VMs 1408.

VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1408 may be a software implementation of a physical machine that runs programs as if they were executing on a physical, non-virtualized machine. Each VM 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of hardware 1404 and corresponds to application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

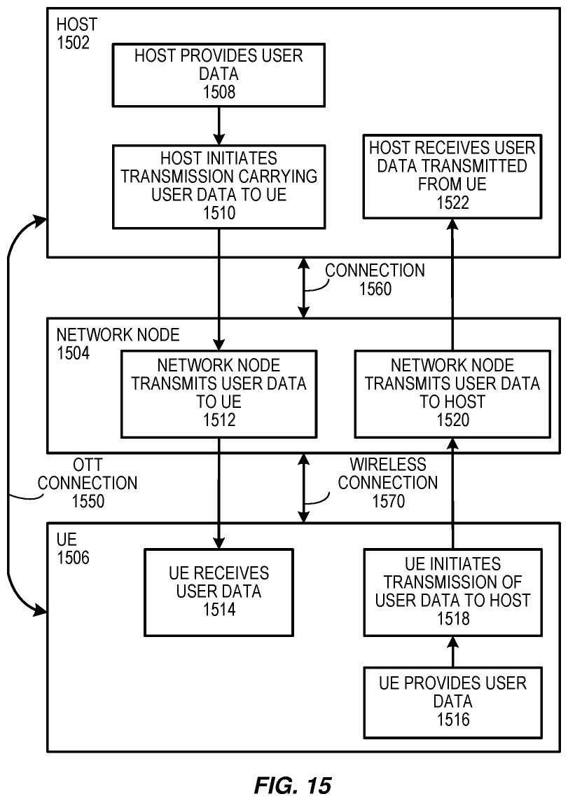

FIG. 15 shows a communication diagram of host 1502 communicating via network node 1504 with UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. Host 1502 also includes software, which is stored in or accessible by host 1502 and executable by the processing circuitry. The software includes a host application that may be operable to provide a service to a remote user, such as UE 1506 connecting via an over-the-top (OTT) connection 1550 extending between UE 1506 and host 1502. In providing the service to the remote user, a host application may provide user data which is transmitted using OTT connection 1550.

Network node 1504 includes hardware enabling it to communicate with host 1502 and UE 1506. Connection 1560 may be direct or pass through a core network (like core network 1006 of FIG. 10) and/or one or more other intermediate networks, such as one or more public, private, or hosted networks. For example, an intermediate network may be a backbone network or the Internet.

UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of host 1502. In host 1502, an executing host application may communicate with the executing client application via OTT connection 1550 terminating at UE 1506 and host 1502. In providing the service to the user, the UE's client application may receive request data from the host's host application and provide user data in response to the request data. OTT connection 1550 may transfer both the request data and the user data. The UE's client application may interact with the user to generate the user data that it provides to the host application through OTT connection 1550.

OTT connection 1550 may extend via a connection 1560 between host 1502 and network node 1504 and via a wireless connection 1570 between network node 1504 and UE 1506 to provide the connection between host 1502 and UE 1506. Connection 1560 and wireless connection 1570, over which OTT connection 1550 may be provided, have been drawn abstractly to illustrate the communication between host 1502 and UE 1506 via network node 1504, without explicit reference to any intermediary devices and the precise routing of messages via these devices.

As an example of transmitting data via OTT connection 1550, in step 1508, host 1502 provides user data, which may be performed by executing a host application. In some embodiments, the user data is associated with a particular human user interacting with UE 1506. In other embodiments, the user data is associated with a UE 1506 that shares data with host 1502 without explicit human interaction. In step 1510, host 1502 initiates a transmission carrying the user data towards UE 1506. Host 1502 may initiate the transmission responsive to a request transmitted by UE 1506. The request may be caused by human interaction with UE 1506 or by operation of the client application executing on UE 1506. The transmission may pass via network node 1504, in accordance with the teachings of the embodiments described throughout this disclosure. Accordingly, in step 1512, network node 1504 transmits to UE 1506 the user data that was carried in the transmission that host 1502 initiated, in accordance with the teachings of the embodiments described throughout this disclosure. In step 1514, UE 1506 receives the user data carried in the transmission, which may be performed by a client application executed on UE 1506 associated with the host application executed by host 1502.

In some examples, UE 1506 executes a client application which provides user data to host 1502. The user data may be provided in reaction or response to the data received from host 1502. Accordingly, in step 1516, UE 1506 may provide user data, which may be performed by executing the client application. In providing the user data, the client application may further consider user input received from the user via an input/output interface of UE 1506. Regardless of the specific manner in which the user data was provided, UE 1506 initiates, in step 1518, transmission of the user data towards host 1502 via network node 1504. In step 1520, in accordance with the teachings of the embodiments described throughout this disclosure, network node 1504 receives user data from UE 1506 and initiates transmission of the received user data towards host 1502. In step 1522, host 1502 receives the user data carried in the transmission initiated by UE 1506.

One or more of the various embodiments improve the performance of OTT services provided to UE 1506 using OTT connection 1550, in which wireless connection 1570 forms the last segment. For example, by providing an AI/ML model's owner/producer with the ability to protect the AI/ML model during various transfer, storage, and retrieval scenarios, embodiments improve the security of confidential and/or sensitive AI/ML models and thereby facilitate deployment of such models in a multi-vendor communication network, such as 5GC. In this manner, embodiments facilitate improvement of network performance using deployed AI/ML models, and consequently increased the value of OTT services delivered over networks improved in this manner.

In an example scenario, factory status information may be collected and analyzed by host 1502. As another example, host 1502 may process audio and video data which may have been retrieved from a UE for use in creating maps. As another example, host 1502 may collect and analyze real-time data to assist in controlling vehicle congestion (e.g., controlling traffic lights). As another example, host 1502 may store surveillance video uploaded by a UE. As another example, host 1502 may store or control access to media content such as video, audio, VR or AR which it can broadcast, multicast or unicast to UEs. As other examples, host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1550 between host 1502 and UE 1506, in response to variations in the measurement results. The measurement procedure and/or the network functionality for reconfiguring the OTT connection may be implemented in software and hardware of host 1502 and/or UE 1506. In some embodiments, sensors (not shown) may be deployed in or in association with other devices through which OTT connection 1550 passes; the sensors may participate in the measurement procedure by supplying values of the monitored quantities exemplified above, or supplying values of other physical quantities from which software may compute or estimate the monitored quantities. The reconfiguring of OTT connection 1550 may include message format, retransmission settings, preferred routing etc.; the reconfiguring need not directly alter the operation of network node 1504. Such procedures and functionalities may be known and practiced in the art. In certain embodiments, measurements may involve proprietary UE signaling that facilitates measurements of throughput, propagation times, latency and the like, by host 1502. The measurements may be implemented in that software causes messages to be transmitted, in particular empty or ‘dummy’ messages, using OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Example embodiments of the techniques and apparatus described herein include, but are not limited to, the following enumerated embodiments:
A1. a method for a consumer network function (NFc) of a COMMUNICATION NETWORK, the method comprising:
   sending, to a first NF of the communication network, a first request for a first access token associated with a machine learning (ML) model, wherein the first request includes one or more of the following associated with the ML model: an analytics identifier (ID), and an interoperability ID;
   receiving from the first NF a first response that includes the first access token;
   sending, to a producer NF (NFp) of the communication network, a second request for the ML model, wherein the second request includes the first access token and at least one of the analytics ID and the interoperability ID; and
   receiving from the NFp a second response that includes one of the following:
      the ML model, or
      a universal resource locator (URL) of a storage resource, associated with a second NF of the communication network, from which the ML model can be obtained.
A2. The method of embodiment A1, wherein the first NF is one of the following: a network repository function (NRF), or an analytics data repository function (ADRF).
A3. The method of any of embodiments A1-A2, wherein one or more of the following applies:
   the NFc is an analytics logical function of a network data analytics function, NWDAF (AnLF); and
   the NFp is a model training logical function of the network data analytics function, NWDAF (MTLF).
A4. The method of any of embodiments A1-A3, wherein:
   the second response includes the ML model, which is encrypted; and
   the second response also includes information usable to locate keys that can be used for decryption and validation of the ML model.
A5. The method of any of embodiments A1-A3, wherein:
   the second response includes the URL; and
   the method further comprises:
      sending, to the first NF, a third request for a second access token associated with the ML model, wherein the third request includes the URL and one or more of the analytics ID and the interoperability ID;
      receiving from the first NF a third response that includes the second access token; and
      obtaining the ML model from the second NF using the second access token and the URL.
A6. The method of embodiment A5, wherein the second NF, from which the ML model is obtained using the URL, is one of the following: the producer NF, or an analytics data repository function (ADRF) of the communication network.
A7. The method of any of embodiments A5-A6, wherein the URL is encrypted, and the second response also includes information usable to locate keys that can be used for decryption and validation of the URL.
B1. A method for a producer network function (NFp) of a communication network, the method comprising:
   registering information associated with a machine learning (ML) model in a network repository function (NRF) of the communication network, wherein:
      the ML model is produced, owned, and/or maintained by the NFp, and
      the registered information includes the following: an analytics identifier (ID); an interoperability ID; and a first universal resource locator (URL) of a storage resource, associated with the NFp, from which the ML model can be obtained; and
   encrypting the ML model and sending, to an analytics data repository function (ADRF) of the communication network, a first request to store the encrypted ML model,
      wherein the first request includes the encrypted ML model or the first URL.
B2. The method of embodiment B1, further comprising
   receiving, from a consumer NF (NFc) of the communication network, a second request for the ML model, wherein the second request includes a first access token and at least one of the analytics ID and the interoperability ID; and
   based on verifying the first access token, sending to the NFc a second response that includes one of the following: the ML model; the first URL; or a second URL of a storage resource, associated with the ADRF, from which the ML model can be obtained.
B3. The method of embodiment B2, wherein:
   the first request includes the first URL; and the second response includes the first URL or the second URL.
B4. The method of embodiment B3, wherein one or more of the following applies:
   the first URL in the first request is encrypted, and the first request also includes information usable to locate keys that can be used for decryption and validation of the first URL; and
   the first or second URL included in the second response is encrypted, and the second response also includes information usable to locate keys that can be used for decryption and validation of the first or second URL.
B5. The method of any of embodiments B3-B4, further comprising:
   receiving from the ADRF a further request for the ML model, wherein the further request includes the first URL and a second access token;
   based on verifying the second access token, sending the ADRF a further response that includes the encrypted ML model; and
   subsequently receiving the second URL from the ADRF and updating the registered information in the NRF to include the second URL.
B6. The method of any of embodiments B3-B5, wherein:
   the second response includes the first URL; and
   the method further comprises:
      receiving, from the NFc, a third request for the ML model, wherein the third request includes the following: a third access token associated with the ML model, the first URL, and one or more of the analytics ID and the interoperability ID; and
      based on verifying the third access token, sending the NFc a third response that includes the ML model.
B7. The method of embodiment B8, wherein the ML model in the third response is encrypted, and the third response also includes information usable to locate keys that can be used for decryption and validation of the ML model.
B8. The method of embodiment B2, further comprising:
   sending, to a network repository function (NRF) of the communication network, a fourth request for an access token associated with the ML model, wherein the fourth request includes one or more of the analytics ID and the interoperability ID;
   receiving the requested access token from the NRF;
   sending to the ADRF a fifth request for the ML model, wherein the fifth request includes the received access token and one or more of the analytics ID and the interoperability ID;
   receiving from the ADRF a fifth response that includes the ML model, which is then included in the second response to the NFc.
B9. The method of any of embodiments B1-B8, wherein one or more of the following applies:
   the NFc is an analytics logical function of a network data analytics function, NWDAF (AnLF); and
   the NFp is a model training logical function of the network data analytics function, NWDAF (MTLF).
C1. A method for a network repository function (NRF) of a communication network, the method comprising:
   registering information associated with a machine learning (ML) model that is produced, owned, and/or maintained by a producer network function (NFp) of the communication network, wherein the registered information includes the following associated with the ML model: an analytics identifier (ID); an interoperability ID; and a first universal resource locator (URL) of a storage resource, associated with the NFp, from which the ML model can be obtained; and
   receiving, from consumer NF (NFc) of the communication network, a first request for a first access token associated with the ML model, wherein the first request includes one or more of the analytics ID and the interoperability ID;
   sending to the NFc a first response that includes the first access token.
C2. The method of embodiment C1, further comprising:
   receiving, from a first NF of the communication network, a second request for a second access token, wherein the second request includes the following:
      one or more of the analytics ID and the interoperability ID; and
      the first URL or a second URL of a storage resource, associated with an analytics data repository function (ADRF) of the communication network, from which the ML model can be obtained; and
   sending to the first NF a second response that includes the second access token.
C3. The method of embodiment C2, wherein the first NF is one of the following: the NFc, or the NFp.
C4. The method of any of embodiments C2-C3, further comprising after registering the information associated with the ML model, updating the registered information to include the second URL.
C5. The method of any of embodiments C1-C4, wherein one or more of the following applies:
   the NFc is an analytics logical function of a network data analytics function, NWDAF (AnLF); and
   the NFp is a model training logical function of the network data analytics function, NWDAF (MTLF).
D1. A method for an analytics data repository function (ADRF) of a communication network, the method comprising:
   receiving, from a producer network function (NFp) of the communication network, a first request to store an encrypted machine learning (ML) model, wherein the first request includes the encrypted ML model or a first universal resource locator (URL) of a storage resource, associated with the NFp, from which the encrypted ML model can be obtained;
   storing the encrypted ML model in a storage resource associated with the ADRF; and
   sending to the NFp a first response that includes a second URL of the storage resource associated with the ADRF.
D2. The method of embodiment D1, wherein:
   the first request includes the first URL; and
   the method further comprises:
      sending to the NFp a further request for the ML model, wherein the further request includes the first URL and a second access token; and
      receiving from the NFp a further response that includes the encrypted ML model.
D3. The method of embodiment D1, further comprising:
   receiving, from a first NF of the communication, a second request for the ML model, wherein the second request includes a third access token and one or more of the analytics ID and the interoperability ID;
   based on verifying the third access token, sending to the first NF a second response that includes the ML model.
D4. The method of embodiment D3, wherein the first NF is one of the following: the NFc, or consumer NF (NFc) of the communication network.
D5. The method of embodiment D4, wherein one or more of the following applies:
   the NFc is an analytics logical function of a network data analytics function, NWDAF (AnLF); and
   the NFp is a model training logical function of the network data analytics function, NWDAF (MTLF).
D6. The method of any of embodiments D3-D5, wherein the ML model in the second response is encrypted, and the second response also includes information usable to locate keys that can be used for decryption and validation of the ML model.
E1. A consumer network function (NFc) of a communication network, wherein:
   the NFc is implemented by communication interface circuitry and processing circuitry that are operably coupled; and
   the processing circuitry and interface circuitry are configured to perform operations corresponding to any of the methods of embodiments A1-A7.
E2. A consumer network function (NFc) of a communication network, the NFc being configured to perform operations corresponding to any of the methods of embodiments A1-A7.
E3. A non-transitory, computer-readable medium storing computer-executable instructions that, when executed by processing circuitry associated with a consumer network function (NFc) of a communication network, configure the NFc to perform operations corresponding to any of the methods of embodiments A1-A7.
E4. A computer program product comprising computer-executable instructions that, when executed by processing circuitry associated with a consumer network function (NFc) of a communication network, configure the NFc to perform operations corresponding to any of the methods of embodiments A1-A7.
F1. A producer network function (NFp) of a communication network, wherein:
   the NFp is implemented by communication interface circuitry and processing circuitry that are operably coupled; and
   the processing circuitry and interface circuitry are configured to perform operations corresponding to any of the methods of embodiments B1-B9.
F2. A producer network function (NFp) of a communication network, the NFp being configured to perform operations corresponding to any of the methods of embodiments B1-B9.
F3. A non-transitory, computer-readable medium storing computer-executable instructions that, when executed by processing circuitry associated with a producer network function (NFp) of a communication network, configure the NFp to perform operations corresponding to any of the methods of embodiments B1-B9.
F4. A computer program product comprising computer-executable instructions that, when executed by processing circuitry associated with a producer network function (NFp) of a communication network, configure the NFp to perform operations corresponding to any of the methods of embodiments B1-B9.
G1. A network repository function (NRF) of a communication network, wherein:
   the NRF is implemented by communication interface circuitry and processing circuitry that are operably coupled; and
   the processing circuitry and interface circuitry are configured to perform operations corresponding to any of the methods of embodiments C1-C5.
G2. A network repository function (NRF) of a communication network, the NRF being configured to perform operations corresponding to any of the methods of embodiments C1-C5.
G3. A non-transitory, computer-readable medium storing computer-executable instructions that, when executed by processing circuitry associated with a network repository function (NRF) of a communication network, configure the NRF to perform operations corresponding to any of the methods of embodiments C1-C5.
G4. A computer program product comprising computer-executable instructions that, when executed by processing circuitry associated with a network repository function (NRF) of a communication network, configure the NRF to perform operations corresponding to any of the methods of embodiments C1-C5.
H1. An analytics data repository function (ADRF) of a communication network, wherein:
   the ADRF is implemented by communication interface circuitry and processing circuitry that are operably coupled; and
   the processing circuitry and interface circuitry are configured to perform operations corresponding to any of the methods of embodiments D1-D6.
H2. An analytics data repository function (ADRF) of a communication network, the ADRF being configured to perform operations corresponding to any of the methods of embodiments D1-D6.
H3. A non-transitory, computer-readable medium storing computer-executable instructions that, when executed by processing circuitry associated with an analytics data repository function (ADRF) of a communication network, configure the ADRF to perform operations corresponding to any of the methods of embodiments D1-D6.
H4. A computer program product comprising computer-executable instructions that, when executed by processing circuitry associated with an analytics data repository function (ADRF) of a communication network, configure the ADRF to perform operations corresponding to any of the methods of embodiments D1-D6.

1.-56. (canceled)

57. A method for a consumer network function (NFc) of a communication network, the method comprising:
sending, to a first network function (NF) of the communication network, a first request for a first access token associated with a machine learning (ML) model, wherein the first request includes at least one of the following associated with the ML model: an analytics identifier, ID, and an interoperability ID;
receiving from the first NF a first response that includes the first access token;
sending, to a producer NF (NFp) of the communication network, a second request for the ML model, wherein the second request includes the first access token and at least one of the analytics ID and the interoperability ID; and
receiving from the NFp a second response that includes one or more of the following:
the ML model,
an identifier of the ML model, and
an address of a storage resource associated with a second NF of the communication network, from which the ML model can be obtained.

58. The method of claim 57, wherein one or more of the following applies:
the first NF is one of the following: a network repository function (NRF), or an analytics data repository function (ADRF).
the NFc is an analytics logical function of a network data analytics function, NWDAF(AnLF); and
the NFp is a model training logical function of the network data analytics function, NWDAF(MTLF).

59. The method of claim 57, wherein:
the second response includes the ML model, which is encrypted; and
the second response also includes information usable to locate keys that can be used for decryption and validation of the ML model.

60. The method of claim 57, wherein the second response includes the address of the storage resource associated with the second NF, and the method further comprises:
sending, to the first NF, a third request for a second access token associated with the ML model, wherein the third request includes the following: the address of the storage resource associated with the second NF, and at least one of the analytics ID and the interoperability ID;
receiving from the first NF a third response that includes the second access token; and
obtaining the ML model from the second NF using the second access token and the address of the storage resource associated with the second NF.

61. The method of claim 60, wherein the address of the storage resource is encrypted, and the second response also includes information usable to locate keys that can be used for decryption and validation of the address of the storage resource.

62. The method of claim 57, wherein the address of the storage resource associated with the second NF is a universal resource locator (URL) or a fully qualified domain name (FQDN).

63. The method of claim 57, wherein the second NF is one of the following: the NFp, or an analytics data repository function (ADRF).

64. A method for a producer network function (NFp) of a communication network, the method comprising:
registering information associated with a machine learning (ML) model in a network repository function (NRF) of the communication network, wherein:
the ML model is produced, owned, and/or maintained by the NFp, and
the registered information associated with the ML includes an analytics identifier, ID, and an interoperability ID; and
encrypting the ML model and sending, to an analytics data repository function (ADRF) of the communication network, a first request to store the encrypted ML model, wherein the first request includes one of the following: the encrypted ML model, or a first address of a storage resource associated with the NFp, from which the ML model can be obtained.

65. The method of claim 64, further comprising
receiving, from a consumer NF (NFc) of the communication network, a second request for the ML model, wherein the second request includes a first access token and at least one of the analytics ID and the interoperability ID; and
based on verifying the first access token, sending to the NFc a second response that includes one or more of the following:
the ML model,
an identifier of the ML model,
the first address of the storage resource associated with the NFp, or
a second address of a storage resource associated with the ADRF, from which the ML model can be obtained.

66. The method of claim 65, wherein:
the first address of the storage resource associated with the NFp is a first universal resource locator (URL); and
the second address of the storage resource associated with the ADRF is a second URL or a fully qualified domain name (FQDN).

67. The method of claim 65, wherein:
the first request includes the first address of the storage resource associated with the NFp; and
the second response includes the first address of the storage resource associated with the NFp or the second address of the storage resource associated with the ADRF.

68. The method of claim 67, wherein one or more of the following applies:
the first address included in the first request is encrypted, and the first request also includes information usable to locate keys that can be used for decryption and validation of the first address; and
the first or second address included in the second response is encrypted, and the second response also includes information usable to locate keys that can be used for decryption and validation of the first or second address.

69. The method of claim 67, further comprising:
receiving from the ADRF a further request for the ML model, wherein the further request includes a second access token and the first address of the storage resource associated with the NFp;
based on verifying the second access token, sending the ADRF a further response that includes the encrypted ML model; and
subsequently receiving from the ADRF the second address of the storage resource associated with the ADRF.

70. The method of claim 69, wherein the registered information associated with the ML model also includes the first address of the storage resource associated with the NFp, and the method further comprises updating the registered information associated with the ML model in the NRF to include the received second address.

71. The method of claim 67, wherein the second response includes the first address of the storage resource associated with the NFp, and the method further comprises:
receiving, from the NFc, a third request for the ML model, wherein the third request includes the following: a third access token associated with the ML model, the first address, and at least one of the analytics ID and the interoperability ID; and
based on verifying the third access token, sending to the NFc a third response that includes the ML model.

72. The method of claim 71, wherein the ML model included in the third response is encrypted, and the third response also includes information usable to locate keys that can be used for decryption and validation of the ML model.

73. The method of claim 65, further comprising:
sending, to a network repository function (NRF) of the communication network, a fourth request for an access token associated with the ML model, wherein the fourth request includes at least one of the analytics ID and the interoperability ID;
receiving the requested access token from the NRF;
sending to the ADRF a fifth request for the ML model, wherein the fifth request includes the received access token and at least one of the analytics ID and the interoperability ID; and
receiving from the ADRF a fifth response that includes the ML model, which is then included in the second response to the NFc.

74. A method for an analytics data repository function (ADRF) of a communication network, the method comprising:
receiving, from a producer network function (NFp) of the communication network, a first request to store an encrypted machine learning (ML) model, wherein the first request includes the encrypted ML model or a first address of a storage resource associated with the NFp, from which the encrypted ML model can be obtained;
storing the encrypted ML model in a storage resource associated with the ADRF; and
sending to the NFp a first response that includes a second address of the storage resource associated with the ADRF.

75. The method of claim 74, wherein the first request includes the first address of the storage resource associated with the NFp, and the method further comprises:
sending to the NFp a further request for the ML model, wherein the further request includes the first address and a second access token; and
receiving from the NFp a further response that includes the encrypted ML model, which is then stored in the storage resource associated with the ADRF.

76. The method of claim 74, further comprising:
receiving, from a first NF of the communication, a second request for the ML model, wherein the second request includes a third access token and at least one of the analytics ID and the interoperability ID; and
based on verifying the third access token, sending to the first NF a second response that includes the ML model.

77. The method of claim 76, wherein one or more of the following applies:
the first NF is the NFp or an analytics logical function of a network data analytics function, NWDAF(AnLF); and
the NFp is a model training logical function of the network data analytics function, NWDAF(MTLF).

78. Network equipment configured to implement a consumer network function (NFc) of a communication network, the network equipment comprising:
communication interface circuitry arranged to communicate with other network functions of the communication network; and
processing circuitry operably coupled to the communication interface circuitry, wherein the processing circuitry and the communication interface circuitry are configured to perform the method of claim 57.

79. Network equipment configured to implement a producer network function (NFp) of a communication network, the network equipment comprising:
communication interface circuitry arranged to communicate with other network functions of the communication network; and
processing circuitry operably coupled to the communication interface circuitry, wherein the processing circuitry and the communication interface circuitry are configured to perform the method of claim 64.

80. Network equipment configured to implement an analytics data repository function (ADRF) of a communication network, the network equipment comprising:
communication interface circuitry arranged to communicate with other network functions of the communication network; and
processing circuitry operably coupled to the communication interface circuitry, wherein the processing circuitry and the communication interface circuitry are configured to perform the method of claim 74.
